(19) United States
(12) Patent Application Publication
(10) Pub. No.: US 2012/0186728 A1
(43) Pub. Date: Jul. 26, 2012

(54) METHOD FOR ELIMINATING UNEVENNESSES IN SEALING SURFACES

(76) Inventor: Peter Kummeth, Herzogenaurach (DE)

(21) Appl. No.: 13/499,246

(22) PCT Filed: Sep. 28, 2010
(86) PCT No.: PCT/EP10/64360

§ 371 Date: Mar. 29, 2012

(30) Foreign Application Priority Data
Sep. 29, 2009 (DE) 10 2009 043 632.4

(51) Int. Cl. B32B 37/12; B32B 38/16; B23K 31/00; B32B 37/10; B32B 38/10

(52) U.S. Cl. 156/153; 156/60; 156/281; 228/125

(57) ABSTRACT

A connecting point between first and a second devices is sealed with respect to the passage of liquids through the connecting point by applying a soft solid onto the surface and pressing the soft solid into depressions in the surface for sealing purposes.

This application is the U.S. national stage of International Application No. PCT/EP2010/064360, filed Sep. 28, 2010 and claims the benefit thereof. The International Application claims the benefits of German Application No. 10 2009 043 632.4 filed on Sep. 29, 2009, both applications are incorporated by reference herein in their entirety.

### BACKGROUND

Described below is a method for eliminating unevennesses in sealing surfaces by applying a soft solid to the surface for sealing and pressing the soft solid into depressions in the surface for sealing.

In vacuum chambers with reclosable openings O-rings are often used as seals. To this end, the sealing surfaces onto which the O-rings are pressed must have as smooth a surface as possible. In particular, no grooves must be present which extend transversely of the sealing material of the O-ring and might cause a vacuum leak.

Grooves and other defects in the sealing surfaces are as a rule removed prior to sealing by time-consuming manual grinding or polishing in order to produce the smooth surface. However, this can only take place if the grooves and defects are not too deep, typically less than a hundredth of a millimeter. In the case of sealing surfaces with severe defects, the sealing surface has to be remachined on a lathe.

### SUMMARY

The method for eliminating unevennesses in sealing surfaces is a simple, time-saving method by which sealing surfaces may be restored to the smooth state, without depressions such as grooves or defects.

The method for eliminating unevennesses in sealing surfaces includes providing a first device having a surface for sealing a junction between the first and a second device with regard to the passage of fluids through the junction, applying a soft solid to the surface for sealing, and pressing the soft solid into depressions in the surface for sealing.

The depressions in the surface for sealing are filled quickly and easily by application of the soft solid. Grinding to remove the depressions or post-machining of the sealing surface on a lathe may be dispensed with. The sealing surfaces may be smooth, so in particular preventing leaks caused by transverse grooves on sealing. Placing of a sealing ring onto the sealing surface makes it possible to produce a fluid-tight connection between sealing ring and sealing surface.

The surface for sealing may be cleaned prior to the above-described method. This makes it easier to fill the depressions with the soft material and produce a smooth surface.

The soft solid may be heat treated after the above-described method. This may simplify or allow complete filling of depressions with the soft material, any air bubbles or voids additionally being filled in.

The soft solid used may be a material which has a lower melting point than the material of the surface of the first device. The heat treatment may be performed in a temperature range between the melting point of the soft solid and the melting point of the material of the surface of the first device. This ensures that the smooth areas of the surface of the first device without soft solid, i.e. without depressions, are not damaged or deformed.

The soft solid may be removed again completely or partially from the surface for sealing, with the exception of the soft solid in the depressions. In this way, only the depressions are filled in and the stability of the overall sealing surface is not reduced unnecessarily. Soft solid in areas without depressions may cause problems on sealing the second device and be forced out between the first and second device by a fluid in the sealed state. This may impair the sealing properties at the junction of the devices.

Removal may be performed by scraping and/or grinding off.

The soft solid used may be a metal or a metal alloy. Metals with low vapor pressure are particularly suitable. Thus, for example, lead and/or indium may be used as the soft solid. These materials are easy to apply and work but nonetheless result in stable filling of the depressions, so providing a degree of resistance to a fluid.

Alternatively, epoxy resin may be used as the soft solid. The epoxy resin may be applied in liquid form and forms the solid in the depressions or the epoxy resin is pressed firmly into the depressions. Excess epoxy resin may then be removed again, such that only the depressions are filled.

The material of the surface of the first device may be a metal, in particular a stainless steel.

All the depressions in the surface for sealing should be completely filled with the soft solid. A surface is then obtained which provides an absolutely fluid-tight seal together with the second device. The seal is particularly easy to produce if the surface for sealing is completely smooth.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a sectional representation through a vacuum chamber with lid and an O-ring seal, and

FIG. 2 is a plan view of a sealing surface of the vacuum chamber, on which is placed an O-ring, and

FIG. 3 is a plan view of the sealing surface of FIG. 2 without O-ring after use with grooves prior to performance of the method, and

FIG. 4 is a sectional representation through the hollow cylinder of the vacuum chamber with grooves caused by wear.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

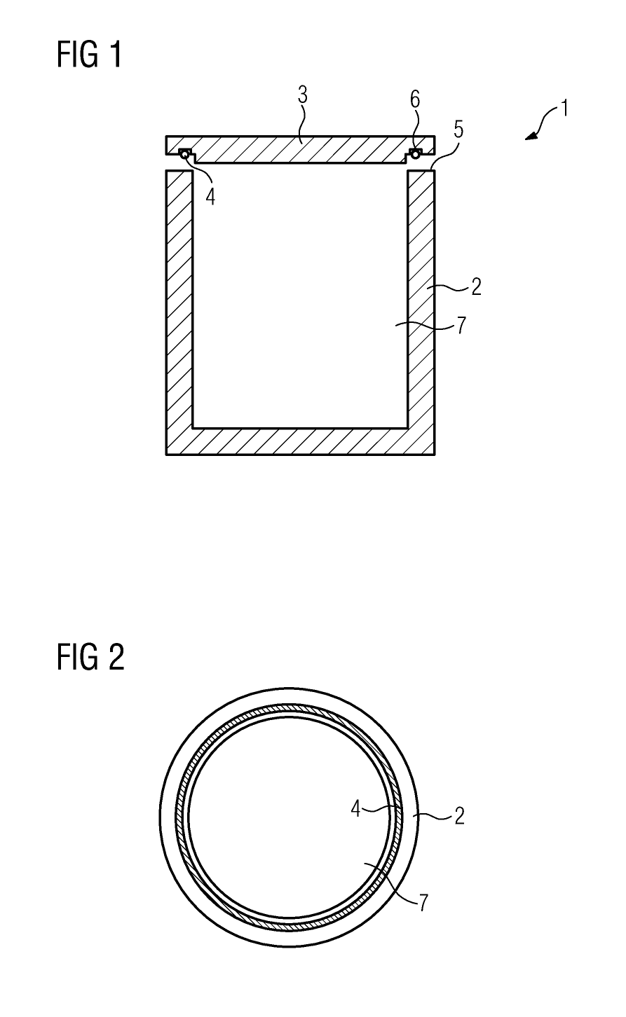

FIG. 1 shows a section through a hollow-cylindrical vacuum chamber 1. The section is taken along a longitudinal axis of the vacuum chamber 1. The vacuum chamber 1 is formed of a hollow cylinder 2 open at the top and a lid 3, between which an O-ring 4 is arranged. When closed, the chamber 1 may be evacuated and the vacuum is stable inside the vacuum chamber 1 for long periods through fluid-tight connection of the lid 3, the O-ring 4 and the hollow cylinder 2. Being a fluid, air is incapable of entering the interior of the vacuum chamber 1 via the fluid-tight connection.

For a fluid-tight connection between hollow cylinder 2 and O-ring 4 and between lid 3 and O-ring 4, it is essential for the sealing surfaces 5, 6 to be as smooth as possible. The smoother the sealing surfaces 5 and 6, the less pressure has to be exerted on the sealing ring 4 for sealing purposes or the more fluid-tightly the vacuum chamber 1 is closed.

FIG. 2 shows a plan view of the hollow cylinder 2 shown in FIG. 1 without lid 3. In plan view from above onto the opening of the hollow cylinder, the hollow cylinder or its wall is of circular, annular construction. The O-ring 4 is placed for sealing purposes onto the top of the wall of the hollow cylinder 2. The sealing surface 5 is the surface below the O-ring on the top of the wall of the hollow cylinder 2, which in plan view completely surrounds the interior 7 of the hollow cylinder 2. The O-ring 4 is as a rule secured in a groove in the lid 3, but may alternatively also lie on the sealing surface 5 when the vacuum chamber 1 is open.

The hollow cylinder 2 and the lid 3 are made of stainless steel, for example. The O-ring 4 is made of copper, for example, to achieve a good seal up to the ultra-high vacuum range. Where there are smaller pressure differences between the interior 7 and the surrounding environment of the vacuum chamber 1 when the latter is closed, e.g. when a simple vacuum is formed in the interior 7, materials may also be used for the O-ring such as for example vulcanized or unvulcanized rubber or Teflon.

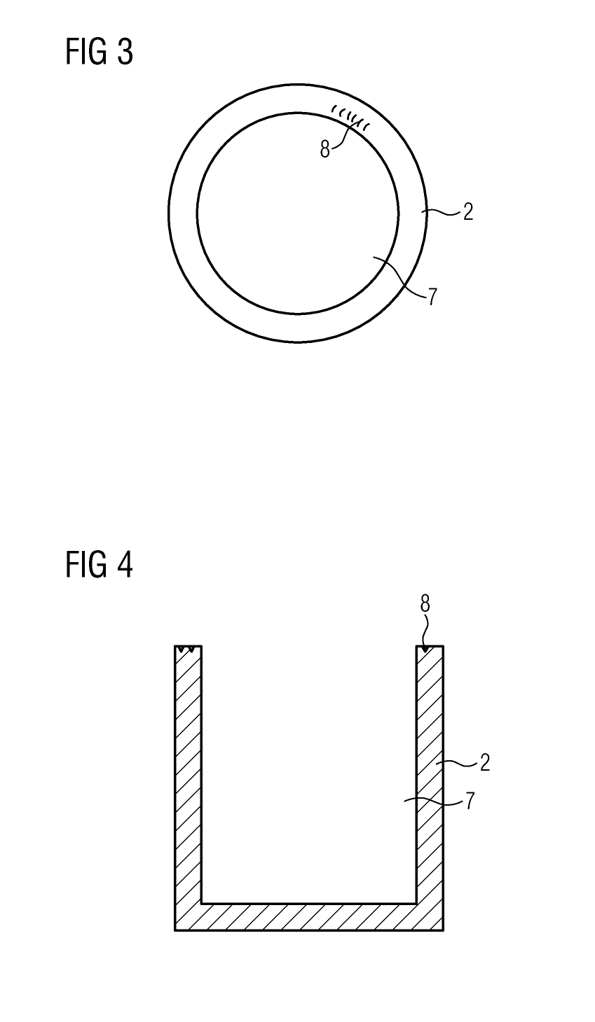

FIG. 3 shows the sealing surface 5 after use or with manufacturing defects, i.e. after opening of a closed, tight vacuum chamber 1 and removal of the O-rings 4. For the sake of simplicity, grooves and channels or depressions 8 are shown only in one portion. The depressions 8 are formed on the sealing surface 5 and arise on removal of the O-ring 4. On sealing of the vacuum chamber 1 the material of the hollow cylinder 2 is pressed together with the material of the O-ring 4 to such an extent that the materials form mechanically stable connections with one another, which persist after termination of the application of pressure to seal the vacuum chamber 1. The same is true of the lid 3 in the area of the sealing surface 6. When the O-ring 4 is removed from the sealing surface 5 and/or 6, at the same time material belonging to the hollow cylinder 2 or lid 3 is removed from the sealing surface 5 and/or 6. Depressions form in the sealing surfaces 5 and/or 6. Conversely, material from the O-ring 4 may also remain “stuck” to the sealing surfaces 5 and/or 6 and lead to roughening of the hitherto smooth sealing surfaces 5 and/or 6. Prior to re-use and re-sealing of the vacuum chamber 1 the unevennesses in the sealing surfaces 5, 6 have to be eliminated, so that a vacuum seal may be achieved.

FIG. 4 shows depressions 8 by way of example in a sectional view through the hollow cylinder 2. For greater clarity, the depressions 8 are shown exaggeratedly large. As a rule the depressions 8 are of the order of magnitude of up to a few micrometers in width and depth and may take the form of holes or trenches. To eliminate depressions 8, material such as for example indium or lead may be added to the sealing surfaces 5 and/or 6, which is pressed into the depressions 8. Air bubble-free filling of the depressions 8 is achieved thereby. Due to the mechanical properties of the filler material and of the material of the hollow cylinder 2 or lid 3, the latter material having much greater mechanical stability, excess filler material may be removed from the sealing surface 5 and/or 6 without material being removed from the hollow cylinder 2 or the lid 3. This may be effected for example by scratching or scraping filler material off the sealing surface 5 and/or 6, filler material only remaining in depressions on the sealing surface 5 and/or 6. A smooth sealing surface 5 and/or 6 is produced, which allows the vacuum chamber 1 to be resealed in a vacuum-tight manner.

As an alternative to indium or lead, materials such as for example synthetic resins may also be used to fill the depressions 8. For instance, epoxy resin may be packed into the depressions 8 and compacted, excess resin being removed from the sealing surface after curing. Curing of the resins may be accelerated and improved by heat treatment. Cured material may also be used directly for compaction. When using metal such as for example indium, heat treatment may result in better filling of the depressions 8. Low filler material vapor pressure allows a vacuum to be formed in the vacuum chamber 1 without or substantially without evaporation of the filler material. As a result of the newly smooth surfaces of the sealing surfaces 5 and 6, fluid-tight re-sealing of the vacuum chamber 1 is possible in conjunction with the O-ring 4. Complex grinding and polishing of the sealing surfaces 5 and/or 6, or in the case of smaller vacuum chambers 1 machining on a lathe, may be dispensed with. This saves on time and cost.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide V. DIRECTV, 358 F3d 870, 69 USPQ2d 1865 (Fed. Cir. 2004).

1-14. (canceled)

15. A method for eliminating unevennesses in sealing surfaces, comprising:
providing a first device having a surface for sealing a junction between the first and a second device with regard to the passage of fluids through the junction, and
applying a soft solid to the surface for sealing.

16. The method as claimed in claim 15,
further comprising pressing the soft solid into depressions in the surface for sealing, and
wherein the surface for sealing is cleaned prior to at least one of said applying and said pressing.

17. The method as claimed in claim 16, further comprising heat treating the soft solid after at least one of said applying and said pressing.

18. The method as claimed in claim 17, wherein the soft solid used is a material which has a lower melting point than the material of the surface of the first device.

19. The method as claimed in claim 18,
wherein the surface of the first device is formed of a material having a first melting point, and
wherein said heat treating is carried out in a temperature range between a second melting point of the soft solid and the first melting point of the material of the surface of the first device.

20. The method as claimed in claim 19, further comprising removing the soft solid at least partially from the surface for sealing after one of said applying and pressing, except for the soft solid in the depressions.

21. The method as claimed in claim 20, said removing is carried out by at least one of scraping and grinding.

22. The method as claimed in claim 21, wherein the soft solid is one of a metal and a metal alloy.

23. The method as claimed in claim 21, wherein the soft solid is a metal with a low vapor pressure.

24. The method as claimed in claim 21, wherein the soft solid is composed of at least one of lead and indium.

25. The method as claimed in claim 19, wherein the material of the surface of the first device is stainless steel.

26. The method as claimed in claim 17, wherein the soft solid is an epoxy resin.

27. The method as claimed in claim 17, wherein said pressing completely fills all the depressions in the surface for sealing with the soft solid.

28. The method as claimed in claim 15, wherein the surface for sealing is completely smooth.
